(19) United States
(12) Patent Application Publication
(10) Pub. No.: US 2014/0088936 A1
(43) Pub. Date: Mar. 27, 2014

(54) CATALYTIC ZONES IN CONTINUOUS CATALYTIC REACTORS

(71) Applicant: Dow Global Technologies LLC, Midland, MI (US)

(72) Inventors: Paul Witt, Midland, MI (US); Anshul Agarwal, Midland, MI (US); Yisu Nie, Zigong (CN)

(73) Assignee: Dow Global Technologies LLC, Midland, MI (US)

(21) Appl. No.: 14/029,336

(22) Filed: Sep. 17, 2013

Related U.S. Application Data
(60) Provisional application No. 61/705,261, filed on Sep. 25, 2012.

(51) Int. Cl. G06F 19/00

(52) U.S. Cl. CPC G06F 19/702
USPC 703/2

(57) ABSTRACT

A method including converting a predetermined number of catalytic zones into a number of finite elements, where the number of finite elements include a number of collocation points represented by a number of mathematical roots in an algebraic system, modeling a catalyst volume including a length of a continuous reactor to have the predetermined number of catalytic zones, representing the first ordinary differential equation, second ordinary differential equation, and third ordinary differential equations in the algebraic system, and performing orthogonal collocation on the number of finite elements in the algebraic system while simultaneously varying at least one of the first number of polynomials and simultaneously varying a percentage of active catalyst and a length of each of the predetermined number of catalytic zones in the second number of polynomials to obtain the mass flow rate of the product for the given chemical reactions.

### CROSS-REFERENCE

The present patent application claims the benefit of U.S. Provisional Patent Application No. 61/705,261, filed Sep. 25, 2012, which is herein incorporated by reference.

### FIELD OF THE DISCLOSURE

Embodiments of the present disclosure are directed towards continuous catalytic reactors and in particular to fixed-bed continuous catalytic reactors.

### BACKGROUND

Fixed-bed continuous catalytic reactors are employed in a variety of industrial processes. For example, the production of a variety of industrial chemicals may employ fixed-bed continuous catalytic reactors. Fixed-bed continuous catalytic reactors may have more than one reactor bed, such as a number of reactor beds having varying catalyst concentrations.

### SUMMARY

Embodiments of the present disclosure provide a method of determining a mass flow rate of a product for given chemical reactions in a predetermined number of catalytic zones of a continuous reactor. The method can include converting, by a computing device including a processor, the predetermined number of catalytic zones into a number of finite elements, where the number of finite elements can include a number of collocation points represented by a number of mathematical roots in an algebraic system. The method can include modeling, by the processor, a catalyst volume including a length of the continuous reactor to have the predetermined number of catalytic zones, where modeling can include modeling, at the number collocation points, rates for the given chemical reactions and a mass balance as a first ordinary differential equation, an axial temperature profile using a one dimensional model as a second ordinary differential equation, and a pressure drop as a third ordinary differential equation. The method can include representing, by the processor, the first ordinary differential equation, the second ordinary differential equation, and the third ordinary differential equation in the algebraic system, where representing can include representing a number of state variables for the given chemical reactions by a first number of polynomials, representing a number of decision variables for the given chemical reactions by a second number of polynomials, and performing, by the processor, orthogonal collocation on the number of finite elements in the algebraic system while simultaneously varying at least one of the first number of polynomials and simultaneously varying a percentage of active catalyst and a length of each of the predetermined number of catalytic zones in the second number of polynomials to obtain the mass flow rate of the product for the given chemical reactions corresponding to a percentage of active catalyst and a length of each of the predetermined number of catalytic zones.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

FIG. 1 illustrates a block diagram of a method of determining a mass flow rate of a product for given chemical reactions in a predetermined number of catalytic zones of a continuous reactor according to one or more embodiments of the present disclosure.

FIG. 2 illustrates a block diagram of a computing device for determining a mass flow rate of a product for given chemical reactions in a predetermined number of catalytic zones of a continuous reactor according to one or more embodiments of the present disclosure.

### DETAILED DESCRIPTION

Methods of determining a mass flow rate of a product for given chemical reactions in a predetermined number of catalytic zones of a continuous reactor are described herein. The mass flow rate can be useful in designing continuous reactors employed for the production of a variety of industrial chemicals. For descriptive purposes a mass flow rate of phthalic anhydride, relating to selective oxidation of o-xylene to phthalic anhydride is presented herein. However, embodiments are not so limited. The methods employed herein may be utilized to determine a mass flow rate for a number of products, relating to a variety of chemical reactions (e.g., production of a variety of industrial chemicals).

For various embodiments, a number of reactions associated with the production of the desired product can be disregarded (e.g., reverse reactions). For example, in the selective oxidation of o-xylene to phthalic anhydride, three reactions can be considered.

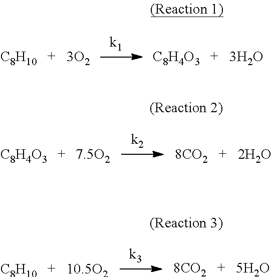

Embodiments of the present disclosure provide a method of determining a mass flow rate of a product for given chemical reactions in a predetermined number of catalytic zones of a continuous reactor. The method can include converting, the predetermined number of catalytic zones into a number of finite elements. The number of finite elements can include a number of collocation points represented by a number of mathematical roots in an algebraic system. The method can include modeling a catalyst volume including a length of the continuous reactor to have the predetermined number of catalytic zones. The modeling can include modeling, at the number collocation points, rates for the given chemical reactions and a mass balance as a first ordinary differential equation, an axial temperature profile using a one dimensional model as a second ordinary differential equation, and a pressure drop as a third ordinary differential equation. The method can include representing (e.g., representing mathematically) the first ordinary differential equation, the second ordinary differential equation, and the third ordinary differential equation in the algebraic system, includes representing a number of state variables for the given chemical reactions by a first number of polynomials, representing a number of decision variables for the given chemical reactions by a second number of polynomials. The method can include performing orthogonal collocation on the number of finite elements in the algebraic system while simultaneously varying at least one of the first number of polynomials and simultaneously varying (e.g., optimizing) a percentage of active catalyst and a length of each of the predetermined number of catalytic zones in the second number of polynomials to obtain the mass flow rate of the product for the given chemical reactions corresponding to a percentage of active catalyst and a length of each of the predetermined number of catalytic zones.

Other methods utilized to affect reactor performance have employed trial and error testing of the reactor and/or bench-scale modeling. Trial and error testing can include physically altering catalyst concentration, altering the number of reactor beds within the continuous reactor, and/or purchasing additional catalyst (e.g., for performing multiple trials). Hence, trial and error testing can be undesirable. Additionally, bench-scale modeling may not accurately represent and/or predict the performance of an actual continuous reactor.

In contrast to those methods, embodiments of the present disclosure can provide benefits such as determining a mass flow rate of a product for given chemical reactions (e.g., in a predetermined number of catalytic zones of a continuous reactor) without the utilizing trial and error testing and/or bench-scale modeling of the continuous reactor. Additionally, embodiments of the present disclosure can provide benefits such as allowing for determining a number of reactor beds and an activity level (e.g., a percentage of active catalyst) within each of the number of reactor beds that can facilitate improved reactor performance (e.g., as compared to reactor performance corresponding to a different number of reactor beds and/or a different activity level within the number of reactor beds). This improved reactor performance can include improved productivity, improved selectivity, and/or improved conversion to the desired product (e.g., an industrial chemical). Accordingly, in various embodiments the activity level and/or the length of the number of reactor beds can vary for each of the number of reactor beds.

Advantageously, embodiments of the present disclosure include solving a number of ordinary differential equations (ODEs) (e.g., representing a mass balance, axial temperature profile, and/or pressure drop for given chemical reactions) by orthogonal collocation to obtain the mass flow rate of the product for the given chemical reactions corresponding to the percentage of active catalyst and a length of each of the predetermined number of catalytic zones. As used herein, orthogonal collocation refers to a mathematical method for determining numerical solutions for ordinary differential equations. For instance, performing orthogonal collocation at the zeros of orthogonal polynomials can transform an ordinary differential equation (ODE) to a number of algebraic equations. In some embodiments, the number of algebraic equations can be solved (e.g., simultaneously) by a suitable numerical mathematical method (e.g., linear programming, nonlinear programming, mixed-integer linear programming, mixed-integer nonlinear programming, stochastic programming, robust programming, semi-definite programming, and/or calculus of variation, among others) to provide numerical solution(s). In some examples, the numerical mathematical method can be employed via, a solver for example, CONOPT®, among others.

As used herein, continuous reactors, such as fixed-bed continuous catalytic reactors, can include a number of reactor beds. In various embodiments, a number of dimensions (e.g., a total length, a diameter, among others) of the continuous reactor can be predetermined. The number of dimensions can be modeled. For example, the number of dimensions of the continuous reactor can be modeled as a 1 inch (e.g., measured by internal diameter) by 29.527 foot single tube continuous reactor. In various embodiments, the total length of the continuous reactor can equal a sum of lengths of the number of finite elements.

As used herein, number of catalytic zones refers to specified areas (e.g., predetermined) equivalent to the number of reactor beds (e.g., the predetermined number of catalytic zones).

As used herein, catalyst refers to a material that facilitates a change in rate of a chemical reaction (e.g., an increase in the rate of the chemical reaction). In one or more embodiments, the catalyst (e.g., an activity catalyst) and an inert material can have similar bulk properties. The bulk properties can be modeled. For example, densities of the active catalyst (e.g., ρ as shown in Table 1) and the inert material can be equal. This can facilitate representing mixtures containing the active catalyst and the inert material by an activity level (e.g., a catalyst activity coefficient). As used herein, activity level refers to a ratio of an amount of the active catalyst compared to an amount of the inert material.

Table 1 provides symbols, descriptions of the symbols, and corresponding units of measure associated with the particular symbols. The symbols in Table 1 are utilized in equations 1-18.

TABLE 1

| | Description | Units |
|---|---|---|
| Constants | | |
| A, B | Taylor series parameters | Kelvin(K)⁻¹, K⁻² |
| Bi | Biot number, (h_{w} * dₜ/(2*k_{r, e}) | — |
| C | Specific enthalpy temperature | — |
| | coefficients | |
| dₜ | Reactor diameter | Foot (ft) |
| Ea | Activation energy | British thermal units per |
| | | pound mole (Btu/lbmol) |
| Ē | Average activation energy | Btu/lbmol |
| F, f | Molar flow rate | Pound mole per hour |
| | | (lbmol/hr) |
| H | Specific enthalpy | Btu/lbmol |
| ΔHi | Heat of reaction | Btu/lbmol |
| h_{w} | Heat transfer coefficient at | Btu/ft²-hr-K |
| | the wall | |
| k_{b} | Reference rate constant | lbmol/lb_{cat}-atmosphere |
| | | (atm)²-hr |
| k | Rate constant | lbmol/lb_{cat}-atm²-hr |
| k_{r, e} | Effective radial thermal | Btu/ft-hr-K |
| | conductivity | |
| M | Molecular weight | lb/lbmol |
| R | Universal gas constant | Btu/lbmol-K |
| r | Rate (e.g., Rᵢ is rate of | lbmol/lb_{cat}-hr |
| | reaction) | |
| Rₜ | Radius of reactor (e.g., radius | ft |
| | of tube) | |
| T | Temperature | ° K |
| T̅ | Reaction average temperature | ° K |
| Vᵣₓ | Reactor volume | ft³ |
| w | Weighting factor | — |
| y | Mole fraction | lbmol % |
| x | Radial coordinate of reactor | ft |
| z | Dimensionless axial position | — |
| Greek | | |
| α | Alpha term | — |
| ν | Stoichiometric coefficient | — |
| ρ | Bulk catalyst density | lb_{cat}/ft³ |
| σ | Activity of catalytic zone | — |
| Subscript | | |
| c | Coolant | — |
| cat | Catalyst | — |
| i | reaction | — |
| j | Species | — |
| o | Outlet | — |
| ox | O-xylene | — |
| O₂ | Oxygen | |
| pa | Phthalic anhydride | — |
| r | Reference | — |
| s | Start (e.g., inlet) | — |
| t | Tube | — |

The figures herein follow a numbering convention in which the first digit or digits correspond to the drawing figure number and the remaining digits identify an element or component in the drawing. As will be appreciated, elements shown in the various embodiments herein can be added, exchanged, and/or eliminated so as to provide a number of additional embodiments of the present disclosure. In addition, discussion of features and/or attributes for an element with respect to one Figure can also apply to the element shown in one or more additional Figures. Embodiments illustrated in the figures are not necessarily to scale.

As used herein, the terms “a,” “an,” “the,” “one or more,” and “at least one” are used interchangeably and include plural referents unless the context clearly dictates otherwise. Unless defined otherwise, all scientific and technical terms are understood to have the same meaning as commonly used in the art to which they pertain. For the purpose of the present invention, additional specific terms are defined throughout.

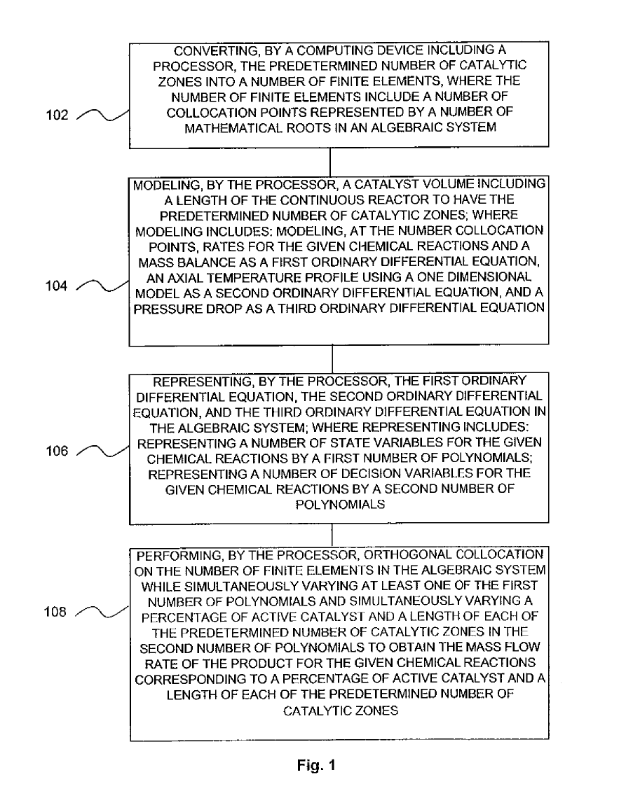

FIG. 1 illustrates a block diagram of a method of determining a mass flow rate of a product for given chemical reactions in a predetermined number of catalytic zones of a continuous reactor according to one or more embodiments of the present disclosure. As shown at block 102, the method can include converting the predetermined number of catalytic zones into a number of finite elements. In various embodiments, the number of finite elements can include a number of collocation points. The collocation points can include fixed collocation points, among others. The collocation points can be represented by a number of mathematical roots in an algebraic system. The number of mathematical roots can include Gauss-Legendre roots and/or Radau roots, among others.

As shown at block 104, the method can include modeling a catalyst volume including a length of the continuous reactor to have the predetermined number of catalytic zones. Modeling the catalyst volume can include modeling, at the number collocation points along the length of the continuous reactor, a plurality of ODEs. The plurality of ODEs can include a mass balance (e.g., molar flow rates of a number of reactants and/or a number of products for the given chemical reactions) as a first ODE, an axial temperature profile using a one dimensional model as a second ODE, and/or a pressure drop as a third ODE, as described herein.

As used herein, catalyst volume refers to a portion of an internal volume of the continuous reactor. For example, the catalyst volume can refer to ¼ of the internal volume of the continuous reactor, ½ of the internal volume of the continuous reactor, ¾ of the internal volume, the entire internal volume of the continuous reactor, among others. As used herein, axial temperature profile refers to a number of temperatures at a number of collocation points along a length (e.g., the total length) of the reactor. As used herein, one dimensional model refers to a model that approximates (e.g., provides one or more numerical approximations) of a number of conditions (e.g., a temperature profile) along one dimension of the continuous reactor (e.g., an axial dimension along a length of the continuous reactor). In various embodiments, the one dimensional model can be an alpha model, for example, as described in “A simple approach to Highly sensitive tubular reactors”, Hagan, Herskowitz and Pirkle, SIAM J. Applied Math, Vol 48, No 5, October 1988, pg 1083-1101, “Accurate one-dimensional Fixed-bed reactor model based on asymptotic analysis”, Herskowitz, and Hagan, AIChE Journal, August 1988, Vol 34, No 8, pg 1367-1372, and/or “An Accurate one-dimensional model for nonadiabatic annular reactors”, Pirkle, Haroon, Kheshgi, and Hagan, August 1991, Vol 37, No 8, pg 1265-1269.

In various embodiments, an inlet temperature of the continuous reactor can be equal to a coolant temperature (e.g., Tₛ equal to T_{c}).

In accordance with another embodiment of the present disclosure an overall reaction rate can be represented by a Taylor's series expansion as shown in Eq. (1).

r(c,T)=r(c, T̅)e^{A(T- T̅)+B(T− T̅)}^{²}^{+ . . . ,} Eq. (1)

where the two parameters A and B can be defined as shown in Eq. (2a) and (2b), respectively.

$$\begin{matrix}A = \frac{d ln r ( c , \overline{T} )}{d \overline{T}} & Eq . ( 2 a ) \\ B = \frac{{d}^{2} ln r ( c , \overline{T} )}{d {\overline{T}}^{2}} & Eq . ( 2 b )\end{matrix}$$

In various embodiments, a model of the axial temperature profile can be determined by solving Eq. (1) where B(T− T̅)²+ . . . can equal 0 (e.g., B(T− T̅)²+ . . . , =0). This can facilitate determining a solution (e.g., an asymptotically correct solution) for the axial temperature profile as shown in Eq. (3).

$$T ( x , α ) = {T}_{c} + ( \frac{4 α}{Bi} - 2 ln ( 1 - α + α {x}^{2} ) ) / A \qquad Eq . ( 3 )$$

As shown in equation 4, α can be determined implicitly.

$$\frac{4 α}{Bi} = A ( \overline{T} - {T}_{c} ) + ln ( 1 - α ) + \frac{B}{3 {A}^{2}} {ln}^{2} ( 1 - α ) , \qquad Eq . ( 4 )$$

In some embodiments, the value of Bi can be constant (e.g., corresponding to the value shown in Table 1). In various embodiments, an amount of heat removed by a coolant (e.g., air, among others coolants) can be represented as

$$- {k}_{r , e} \frac{8 α}{{AR}_{t}^{2}}$$

and substituted into the axial temperature profile (e.g., as shown in Eq. (3)). As shown in Eq. 5, in various embodiments, the method can include determining an average temperature along a radius of the continuous reactor to determine the model of the axial temperature profile.

$$\frac{1}{{R}_{t}^{2}} {\int }_{0}^{{R}_{t}} {k}_{r , e} ( \frac{d T}{d x} + \frac{1}{x} \frac{{d}^{2} T}{d {x}^{2}} ) 2 x d x = - {k}_{r , e} \frac{8 α}{{AR}_{t}^{2}} \qquad Eq . ( 5 )$$

In various embodiments, modeling the mass balance and pressure drop for the given chemical reactions can be determined as shown in the following equations. Reaction kinetics (e.g., reaction rates) for the given chemical reactions can be described via an Arrhenius temperature dependence with respect to a reference temperature (e.g., Tᵣ). For example, the reaction rates for selective oxidation of o-xylene to phthalic anhydride can be considered pseudo-first-order, as shown below in Eqs. (7a)-(7c):

$${k}_{i} = {k}_{{b}_{i}} {e}^{( \frac{{E}_{{a}_{i}} ( T - {T}_{r} )}{{TRT}_{r}} ) ,} \\ i = [ 1 , 2 , 3 ] . \qquad Eq . ( 6 )$$

Accordingly, Eq. (6) can provide rate constants for the above described elementary reactions, such as Reaction 1, Reaction 2, and Reaction 3. In various embodiments, Eqs. (7a)-(7c) can relate the reaction rates to the activity coefficient (e.g., σ), the rate constants (e.g., kᵢ), the partial pressures of gaseous components (e.g., Pⱼ), and/or the bulk catalyst density (e.g., ρ) of the catalyst. Among these, σ can represent the percentage of the active catalyst in a packed reactor bed (e.g., activity of a catalytic zone).

r₁=σk₁PₒₓPₒ_{₂}ρₛ, Eq. (7a)

r₂=σk₂PₚₐPₒ_{₂}ρₛ, Eq. (7b)

r₃=σk₃PₒₓPₒ_{₂}ρₛ, Eq. (7c)

In various embodiments, the partial pressures can be determined by Eq. (8).

Pⱼ=Pₒyⱼ Eq. (8)

where the mole fraction of each component, yⱼ, can be determined by molar flows as shown in Eq. (9).

$${y}_{j} = \frac{{f}_{j}}{{\sum }_{j}^{ } {f}_{j}} \qquad Eq . ( 9 )$$

In various embodiments, based on stoichiometry for the given reactions, the reaction rates for individual chemical species of the given reactions can be determined as shown in Eqs. (10a)-(10f):

rₒₓ=−r₁−r₃, Eq. (10a)

rₚₐ=r₁−r₂, Eq. (10b)

rₕ_{₂}ₒ=3r₁+2r₂+5r₃, Eq. (10c)

rₒ_{₂}=−3r₁−7.5r₂−10.5r₃, Eq. (10d)

r_{co}_{₂}=8r₂+8r₃ Eq. (10e)

rₙ_{₂}=0 Eq. (10f)

In various embodiments, the mass balance and the axial temperature profile can be modeled as ordinary differential equations. This can facilitate accounting for variations in the mass balance and/or the axial temperature profile (e.g., an axial dependence over the bed length). In various embodiments, the mass balances can be written with respect to the molar flow rates of the components (e.g. as shown in Eq. (11)). In a number of embodiments, equations can be based on the total enthalpy of material (e.g., a number of reactants) flow (e.g., as shown in Eq. (12)).

$$\begin{matrix}\frac{d {f}_{j}}{d V} = {r}_{j} , \\ {f}_{j} ( 0 ) = {f}_{{s}_{j}} & Eq . ( 11 ) \\ {\sum }_{j}^{ } {f}_{j} \frac{d H}{d V} = - \frac{8 {ak}_{r , e}}{{AR}_{t}^{2}} - \sum Δ {H}_{i} {r}_{i} , \\ H ( 0 ) = {H}_{s} . & Eq . ( 12 )\end{matrix}$$

In various embodiments, α can account for change in the overall heat transfer coefficient, which can be determined as shown in Eq. (4). Parameters A and B, as discussed in Eq. (4) can be determined by using Eq. (2). An average (e.g., a weighted average) of A and B can be calculated for multiple reactions (e.g., (Rxn1), (Rxn 2), and (Rxn 3)) and incorporated to provide Eqs. (13a) and (13b).

$$\begin{matrix}A = \frac{\overline{E}}{{RT}^{2}} & Eq . ( 13 a ) \\ \frac{B}{{A}^{2}} = - \frac{RT}{\overline{E}} + {\sum }_{i}^{ } \frac{{( {E}_{i}^{r} - \overline{E} )}^{2} {w}_{i}}{2 {\overline{E}}^{2}} & Eq . ( 13 b )\end{matrix}$$

where the average activation energy and the weight of each reaction can be determined by Eqs. (14a) and (14b). For example, i can equal 1, 2, 3, as shown in Eq. (14b).

$$\begin{matrix}\overline{E} = \frac{{\sum }_{i}^{ } {E}_{{a}_{i}} Δ {H}_{i} {r}_{i}}{{\sum }_{i}^{ } Δ {H}_{i} {r}_{i}} & Eq . ( 14 a ) \\ {w}_{i} = \frac{Δ {H}_{i} {r}_{i}}{{\sum }_{i}^{ } Δ {H}_{i} {r}_{i}} , \\ i = 1 , 2 , 3 & Eq . ( 14 b )\end{matrix}$$

Specific enthalpies can be approximated by using polynomials. For example, the specific enthalpies can be approximated utilizing a fifth order temperature dependence, as shown in Eq. (15):

Hⱼ=C0ⱼ+C1ⱼT+C2ⱼT²+C3ⱼT³+C4ⱼT⁴+C5ⱼT⁵ Eq. (15)

In various embodiments, an enthalpy change for a chemical reaction can be viewed as the total enthalpy of the products minus the total enthalpy of the reactants. In various embodiments, released heats of reaction per mole can be described by Eq. (16):

$$Δ {H}_{i} = {\sum }_{j}^{ } {v}_{i , j} \cdot {H}_{j} \qquad Eq . ( 16 )$$

As shown at block 106, the method can include representing, the first ODE, second ODE, and the third ODE in the algebraic system. In various embodiments, representing the first, second, and third ODEs in the algebraic system can include representing a number of state variables for the given chemical reactions by a first number of polynomials and/or representing a number of decision variables for the given chemical reactions by a second number of polynomials, as described herein. The first number of polynomials and/or the second number of polynomials can be Lagrange polynomials and/or Hermite polynomials, among others.

As shown at block 108, the method can include performing orthogonal collocation on the number of finite elements in the algebraic system while simultaneously varying at least one of the first number of polynomials and simultaneously varying a percentage of active catalyst and a length of each of the predetermined number of catalytic zones in the second number of polynomials to obtain the mass flow rate of the product for the given chemical reactions corresponding to a percentage of active catalyst and a length of each of the predetermined number of catalytic zones. In some embodiments, the simultaneously varying can be a numerical mathematical method selected from a group consisting of linear programming, nonlinear programming, mixed-integer linear programming, mixed-integer nonlinear programming, stochastic programming, robust programming, semi-definite programming, calculus of variations, and combinations thereof to vary the first number of polynomials and/or the second number of polynomials, as described herein.

According, in various embodiments a mass flow rate (e.g., maximum flow rate) of desired product (e.g., pthalic anhydride) at the reactor outlet can be determined as shown in equation (17).

Mass flow rate of desired product=Mₚₐ·fₒ_{ₚₐ} Eq. (17)

where fₒ_{ₚₐ} is calculated by orthogonal collocation, as described herein. That is, in various embodiments, the mass flow rate of desired product (e.g., phthalic anhydride) at the reactor outlet can be dependent upon a number of state variables and/or a number of decision variables, among others.

As used herein, number of state variables refers to one or more variables that can remain constant over time and/or the dimensions of the continuous reactor. The number of state variables can be selected from a group including a product selectivity (e.g., a minimum product selectivity), a feed conversion percentage (e.g., a minimum feed conversion percentage), a conversion yield (e.g., a minimum conversion yield), a threshold catalytic zone length (e.g., a maximum catalytic zone length), an amount of heat absorbed, an amount of heat released, a pressure drop, a flow rate of one or more products, and combinations thereof.

As used herein, number of decision variables refers to one or more variables that can vary with time and/or along the dimensions of the continuous reactor. The number of decision variables can be selected from a group including a catalyst activity coefficient, a percentage of active catalyst, a catalyst distribution profile within each of the number of finite elements, a total inlet flow of a number of reactants, a percent conversion of the number of reactants, an inlet temperature, a feed concentration of the number of reactants, an inlet flow rate of each of the number of reactants, a reactor jacket temperature, a coolant temperature, a flow rate of the coolant, a reactor temperature (e.g., a maximum reactor temperature), a length of each of the predetermined number of catalytic zones, and combinations thereof. The number of decision variables can provide degree(s) of freedom for the algebraic equation. For example, the algebraic equation can be solved for the catalyst distribution profile (e.g., a catalyst concentration and/or length of the number of reactor beds), inlet temperature Tᵢ, the coolant temperature T_{c}, and/or the inlet flow rates fsⱼ, among others.

In various embodiments, the state variables can include manufacturing targets. Manufacturing targets can include thresholds (e.g., a minimum feed conversion percentage and/or a maximum reactor temperature, among others). For example, as shown in equations (18a) and (18b), in some embodiments, the manufacturing targets can include specifying a product selectivity (e.g., a minimum product selectivity) and/or a raw material conversion (e.g., a minimum raw material conversion) as thresholds (e.g., 75% and 92.5%) as shown below in Eqs. (18a) and (18b), among others.

$$\begin{matrix}\frac{{fo}_{pa}}{{fs}_{ox} - {fo}_{ox}} \geq 75 \% & Eq . ( 18 a ) \\ \frac{{fs}_{ox} - {fo}_{ox}}{{fs}_{ox}} \geq 92.5 \% & Eq . ( 18 b )\end{matrix}$$

Accordingly, in various embodiments, Eq. (17) can be subject to constraints (e.g., Eqs. (4), (6)-(16)) and/or the manufacturing targets (Eqs. (18a) and/or (18b)) described herein.

Table 2 displays results for the example production of phthalic anhydride as described herein. In various embodiments, a reactor jacket temperature can be constant throughout a reactor jacket of the continuous reactor. As used herein, feed factor refers to a value determined by multiplying all individual feed flow rates (e.g., fₛⱼ) for a given reaction(s) by a common multiplier. In some embodiments, a feed composition (e.g., of one of more of a number of reactants) can be constant (e.g., at 1.12 molar % in air). In some embodiments, a feed concentration of the number of reactants can be constant.

Additionally, Table 2 displays that productivity (e.g., product per volume) can be increased (e.g., by approximately 26%) due to employing two catalytic zones with different activities as determined by the method disclosed herein, in contrast to phthalic anhydride production utilizing a single catalytic zone (e.g., zone 1). Moreover, the addition of a third catalytic zone as determined by the method disclosed herein can further increase productivity (e.g., by approximately 5%).

TABLE 2

| | Product per volume hour | Feed | Jacket T | Maximum T |
|---|---|---|---|---|
| Zone # | lb/(ft³ · hr) | factor | (K) | (K) |
| 1 | 4.953 | 3.98 | 601.23 | 687.0 |
| 2 | 6.263 | 5.03 | 620.97 | 669.8 |
| 3 | 6.587 | 5.29 | 620.62 | 675.2 |
| 4 | 6.649 | 5.34 | 621.64 | 676.8 |
| 5 | 6.655 | 5.35 | 621.74 | 678.3 |
| 10 | 6.656 | 5.35 | 621.77 | 680.1 |
| 20 | 6.656 | 5.35 | 621.77 | 681.1 |

The method can include selecting a total number of catalytic zones of the continuous reactor (e.g., based on the mass flow rate of the product corresponding to the predetermined number of catalytic zones). The desired number of catalytic zones can vary depending upon the desired production of product and corresponding conditions (e.g., desired maximum temperature).

Selection of the total number of catalytic zones of the continuous reactor can be determined mathematically (e.g., via the processor). For instance, by developing a rate of increase (e.g., a slope) of productivity corresponding to the additional number of catalytic zones. Alternatively or in addition, selection of the total number of catalytic zones of the continuous reactor can be determined based on a desired mass flow rate of the product (e.g., corresponding to the predetermined number of catalytic zones). For example, an operator utilizing data (e.g., the data from Table 2) and/or one or more corresponding graphs of the data can identify an appropriate total number of catalytic zones of the continuous reactor based on a desired mass flow rate (e.g., a minimum mass flow rate) of one or more products corresponding to the predetermined number of catalytic zones.

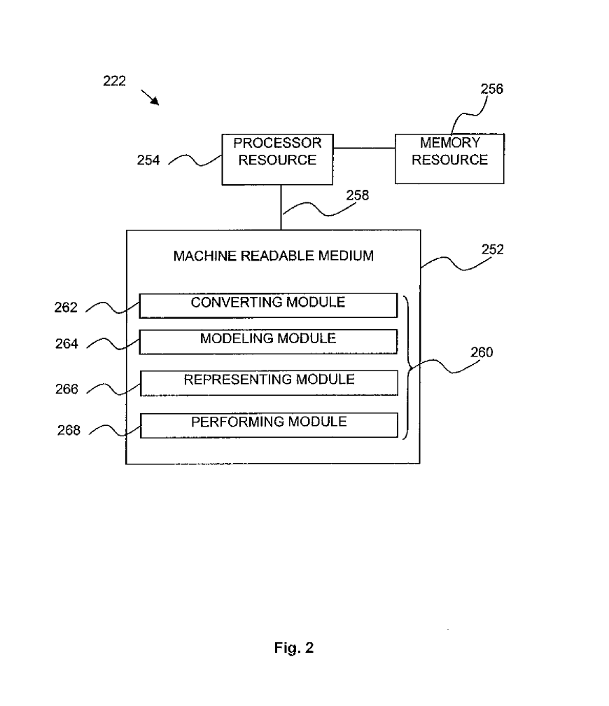

In accordance with another embodiment of the present disclosure FIG. 2 illustrates a block diagram of a computing device 222 for determining a mass flow rate of a product for given chemical reactions in a predetermined number of catalytic zones of a continuous reactor. The computing device 222 can utilize software, hardware, firmware, and/or logic to perform a number of functions. The computing device 222 can include the number of remote computing devices.

The computing device 222 can be a combination of hardware and program instructions configured to perform a number of functions. The hardware can include one or more processing resource 254 (e.g., processors), machine readable medium (MRM) 252, etc. The program instructions (e.g., computer-readable instructions (CRI) 260) can include instructions stored on the MRM 252 and executable by the processing resource 254 to implement a desired function (e.g., send communication to the server management chip, etc.). MRM 252 (e.g., GAMS and/or Athena mathematical solvers, among others) can be in communication with a number of processing resources of more than 254. The processing resource 254 can be in communication with a tangible non-transitory MRM 252 storing a set of CRI 260 executable by one or more of the processing resource 254, as described herein.

The CRI 260 can also be stored in remote memory managed by a server and represent an installation package that can be downloaded, installed, and executed. The computing device 222 can include memory resource 256, and the processing resource 254 can be coupled to the memory resource 256.

Processing resource 254 can execute CRI 260 that can be stored on an internal or external non-transitory MRM 252. The processing resource 254 can execute CRI 260 to perform various functions, including the methods described herein. The CRI 260 can include a number of modules 262 (e.g., a converting module), 264 (e.g., a modeling module), 266 (e.g., a representing module), 268 (e.g., a performing module). The number of modules 262, 264, 266, 268 can include CRI that when executed by the processing resource 254 can perform a number of functions according to the present disclosure.

A non-transitory MRM 252, as used herein, can include volatile and/or non-volatile memory. Volatile memory can include memory that depends upon power to store information, such as various types of dynamic random access memory (DRAM), among others. Non-volatile memory can include memory that does not depend upon power to store information. For example, non-volatile memory can include solid state media such as flash memory, electrically erasable programmable read-only memory (EEPROM), phase change random access memory (PCRAM), magnetic memory such as a hard disk, tape drives, floppy disk, and/or tape memory, optical discs, digital versatile discs (DVD), Blu-ray discs (BD), compact discs (CD), and/or a solid state drive (SSD), etc., as well as other types of computer-readable media.

The non-transitory MRM 252 can be integral, or communicatively coupled, to a computing device, in a wired and/or a wireless manner. For example, the non-transitory MRM 252 can be an internal memory, a portable memory, a portable disk, or a memory associated with another computing resource (e.g., enabling CRIs 260 to be transferred and/or executed across a network such as the Internet).

The MRM 252 can be in communication with the processing resources 254 via a communication path 258. The communication path 258 can be local or remote to a machine (e.g., a computer) associated with the processing resources 254. For example, a local communication path 258 can include an electronic bus internal to a machine (e.g., a computer) where the MRM 252 is one of volatile, non-volatile, fixed, and/or removable storage medium in communication with the processing resources 254 via the electronic bus. Examples of such electronic buses can include Industry Standard Architecture (ISA), Peripheral Component Interconnect (PC I), Advanced Technology Attachment (ATA), Small Computer System Interface (SCSI), Universal Serial Bus (USB), among other types of electronic buses and variants thereof.

The communication path 258 can be such that the MRM 252 is remote from the processing resources e.g., processing resources 254, such as in a network connection between the MRM 252 and the processing resources (e.g., processing resources 254). That is, the communication path 258 can be a network connection. Examples of such a network connection can include a local area network (LAN), wide area network (WAN), personal area network (PAN), and the Internet, among others. In such examples, the MRM 252 can be associated with a first computing device and the processing resources 254 can be associated with a second computing device (e.g., a Java® server). For example, a processing resource 254 can be in communication with a MRM 252, where the MRM 252 includes a set of instructions and wherein the processing resource 254 is designed to carry out the set of instructions.

As used herein, logic refers to an alternative or additional processing resource to perform a particular action and/or function, etc., described herein, which includes hardware (e.g., various forms of transistor logic, application specific integrated circuits (ASICs), etc.), as opposed to computer executable instructions (e.g., software, firmware, etc.) stored in memory and executable by a processor.

It is to be understood that the above description has been made in an illustrative fashion, and not a restrictive one. Although specific embodiments have been illustrated and described herein, those of ordinary skill in the art will appreciate that other component arrangements can be substituted for the specific embodiments shown. The claims are intended to cover such adaptations or variations of various embodiments of the disclosure, except to the extent limited by the prior art.

In the foregoing Detailed Description, various features are grouped together in exemplary embodiments for the purpose of streamlining the disclosure. This method of disclosure is not to be interpreted as reflecting an intention that any claim requires more features than are expressly recited in the claim. Rather, as the following claims reflect, inventive subject matter lies in less than all features of a single disclosed embodiment. Thus, the following claims are hereby incorporated into the Detailed Description, with each claim standing on its own as a separate embodiment of the invention.

What is claimed is:

1. A computer implemented method of determining a mass flow rate of a product for given chemical reactions in a predetermined number of catalytic zones of a continuous reactor comprising:
converting, by a computing device including a processor, the predetermined number of catalytic zones into a number of finite elements, wherein the number of finite elements include a number of collocation points represented by a number of mathematical roots in an algebraic system;
modeling, by the processor, a catalyst volume including a length of the continuous reactor to have the predetermined number of catalytic zones; wherein modeling includes:
modeling, at the number collocation points, rates for the given chemical reactions and a mass balance as a first ordinary differential equation, an axial temperature profile using a one dimensional model as a second ordinary differential equation, and a pressure drop as a third ordinary differential equation;
representing, by the processor, the first ordinary differential equation, the second ordinary differential equation, and the third ordinary differential equation in the algebraic system; wherein representing includes:
representing a number of state variables for the given chemical reactions by a first number of polynomials;
representing a number of decision variables for the given chemical reactions by a second number of polynomials; and
performing, by the processor, orthogonal collocation on the number of finite elements in the algebraic system while simultaneously varying at least one of the first number of polynomials and simultaneously varying a percentage of active catalyst and a length of each of the predetermined number of catalytic zones in the second number of polynomials to obtain the mass flow rate of the product for the given chemical reactions corresponding to a percentage of active catalyst and a length of each of the predetermined number of catalytic zones.

2. The method of claim 1, wherein the one dimensional model comprises an alpha model.

3. The method of claim 1, including selecting a total number of catalytic zones of the continuous reactor based on the mass flow rate of the product corresponding to the predetermined number of catalytic zones.

4. A method of designing a continuous reactor, comprising determining a mass flow rate of a product in each of a predetermined number of catalytic zones of a continuous reactor according to the method of claim 1; and selecting a total number of catalytic zones of the continuous reactor based on the mass flow rate of the product corresponding to the predetermined number of catalytic zones.

5. The method of claim 4, wherein performing includes one or more of the following: determining a feed factor, determining a jacket temperature for the continuous reactor at the number of collocation points along the length of the continuous reactor, or determining a maximum temperature of the continuous reactor at the number of collocation points along the length of the continuous reactor.

6. The method of claim 4, wherein a number of state variables are selected from a group including a minimum product selectivity, a minimum feed conversion percentage, a conversion yield, a maximum catalytic zone length, an amount of heat absorbed, an amount of heat released, a pressure drop, a feed concentration of one or more reactants, a flow rate of one or more products and combinations thereof.

7. The method of claim 4, wherein a number of decision variables are selected from a group including a catalyst activity coefficient, a percentage of active catalyst, a catalyst distribution profile within each of the number of finite elements, a total inlet flow of a number of reactants, a percent (%) conversion of the number of reactants, an inlet temperature, an inlet flow rate of each of the number of reactants, a reactor jacket temperature, a coolant temperature, a flow rate of the coolant, a maximum reactor temperature, a length of each of the predetermined number of catalytic zones, and combinations thereof.

8. The method of claim 4, wherein representing the first number of polynomials comprises Lagrange or Hermite polynomials, the second number of polynomials comprises Lagrange or Hermite polynomials, and representing the number of collocation points comprises Gauss-Legendre or Radau roots.

9. The method of claim 4, further comprising a percentage of inert, wherein the percentage of inert and a percentage of active catalyst comprises a catalyst distribution for each of the predetermined number of catalytic zones of the continuous reactor.

10. The method of claim 4, wherein the simultaneously varying is a numerical mathematical method selected from a group consisting of linear programming, nonlinear programming, mixed-integer linear programming, mixed-integer nonlinear programming, stochastic programming, robust programming, semi-definite programming, calculus of variations, and combinations thereof.
